(19) United States
(12) Patent Application Publication
(10) Pub. No.: US 2019/0384505 A1
(43) Pub. Date: Dec. 19, 2019

(54) INFORMATION PROCESSING DEVICE, PARTS SELECTION METHOD, AND COMPUTER-READABLE RECORDING MEDIUM

(71) Applicant: FUJITSU LIMITED, Kawasaki-Shi (JP)

(72) Inventor: Tatsuya Yamamoto, Kawasaki (JP)

(73) Assignee: FUJITSU LIMITED, Kawasaki-shi (JP)

(21) Appl. No.: 16/418,417

(22) Filed: May 21, 2019

(30) Foreign Application Priority Data
Jun. 18, 2018 (JP) 2018-115450

(51) Int. Cl. G06F 3/06; G06F 3/14

(52) U.S. Cl. CPC G06F 3/0616; G06F 3/14

(57) ABSTRACT

An information processing device, includes: a memory; and a processor that executes a process including: determining, with respect to a plurality of previous sets of parts selection data of a designer, based on degree of concordance of specifications of parts and reference record of price information of each part, whether selection of concerned part is meant to deal with electronics manufacturing service (EMS) or with end of life (EOL) issue, and recording determination result in the parts selection data; performing, when the designer performs selection of a part and the EMS represents condition for the selection, similarity search with respect to parts selection data for which the determination result indicates the EMS; and performing, when the designer performs selection of a part and the EOL issue represents condition for the selection, similarity search with respect to parts selection data for which the determination result indicates the EOL issue.

### CROSS-REFERENCE TO RELATED APPLICATION

This application is based upon and claims the benefit of priority of the prior Japanese Patent Application No. 2018-115450, filed on Jun. 18, 2018, the entire contents of which are incorporated herein by reference.

### FIELD

The embodiment discussed herein is related to an information processing device, a parts selection method, and a computer-readable recording medium.

### BACKGROUND

As far as design revision of an electronic circuit is concerned, for example, design revision is performed to deal with the end of life (EOL) issue on account of the need to change the design due to the end of a part's life, or design revision is performed to deal with the electronics manufacturing service (EMS) that is meant for proposing replacement parts when manufacturing is done based on the parts list received from the customer. At the time of performing such design revision, the designer selects the replacement parts. In the case of dealing with the EOL issue, in order to avoid revision of the printed-circuit board as much as possible, the parts having the same specifications as the EOL-target parts are searched. On the other hand, in the case of dealing with the EMS, not only the parts having the same specifications as the EMS-target parts are searched, but the parts having a lower unit price are also searched for achieving cost cutting. Hence, more searches are performed for the parts having different specifications. In such searching for parts, for example, replacement parts are sometimes recommended by displaying the parts having similar specifications at the top of the search result.

Japanese Laid-open Patent Publication No. 9-293089

At the time of selecting EOL-target parts or EMS-target parts, the designer often wishes to perform a similarity search using parts selection data (a search log) corresponding to past design revisions dealing with the EOL issue or dealing with the EMS, and to refer to the information having a high degree of similarity. However, in the parts selection data obtained in the past, there is no record of the information indicating whether the parts selection corresponds to design revision dealing with the EOL issue or corresponds to design revision dealing with the EMS. Thus, even if the replacement parts are recommended by using the previous parts selection data without modification, the parts recommendation accuracy undergoes deterioration.

### SUMMARY

According to an aspect of an embodiment, an information processing device, includes: a memory; and a processor coupled to the memory. The processor executes a process including: determining, with respect to a plurality of previous sets of parts selection data of a designer, based on degree of concordance of specifications of parts and based on reference record of price information of each part, whether selection of concerned part is meant to deal with electronics manufacturing service (EMS) or with end of life (EOL) issue, and recording determination result in the parts selection data; and searching that includes performing, when the designer performs selection of a part and the EMS represents condition for the selection, similarity search with respect to parts selection data for which the determination result indicates the EMS, and performing, when the designer performs selection of a part and the EOL issue represents condition for the selection, similarity search with respect to parts selection data for which the determination result indicates the EOL issue.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an exemplary configuration of an information processing device according to an embodiment;

FIG. 2 is a diagram illustrating an example of the characteristics of the information appearing in search logs;

FIG. 3 is a diagram illustrating an example of determination criteria;

FIG. 4 is a diagram illustrating an example of a parts information storing unit;

FIG. 5 is a diagram illustrating an example of a system log storing unit;

FIG. 6 is a diagram illustrating an example of an extraction log storing unit;

FIG. 7 is a diagram illustrating an example of an attribute table storing unit;

FIG. 8 is a diagram illustrating another example of the attribute table storing unit;

FIG. 9 is a diagram illustrating an example of recommendation based on collaborative filtering;

FIG. 10 is a diagram illustrating an example of updating a parts list dealing with the end of life (EOL) issue;

FIG. 11 is a diagram illustrating an example of updating a parts list dealing with the electronics manufacturing service (EMS);

FIG. 12 is a flowchart for explaining an example of an attribute table generation operation according to the embodiment;

FIG. 13 is a flowchart for explaining an example of a calculation operation;

FIG. 14 is a flowchart for explaining an example of a determination operation;

FIG. 15 is a flowchart for explaining an example of a search operation according to the embodiment; and

FIG. 16 is a diagram illustrating an example of a computer that executes a parts selection program.

### DESCRIPTION OF EMBODIMENT

Preferred embodiments of the present invention will be explained with reference to accompanying drawings. However, the disclosed technology is not limited by the embodiment described below. Moreover, the embodiments can be appropriately combined without causing any contradiction.

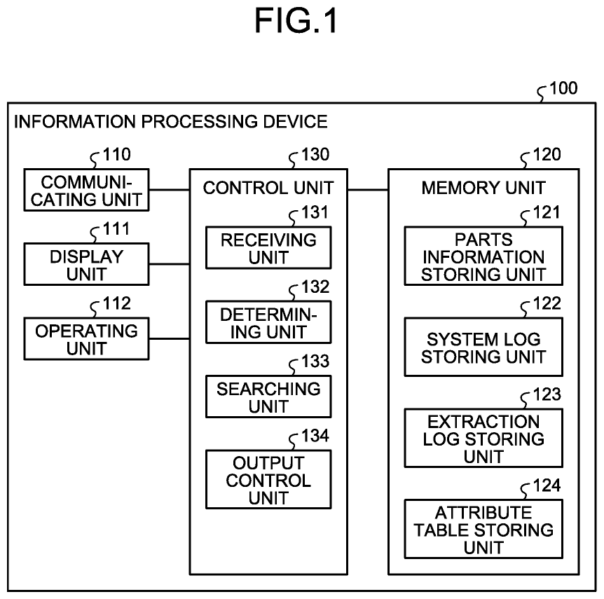

FIG. 1 is a block diagram illustrating an exemplary configuration of the information processing device according to the embodiment. An information processing device 100 illustrated in FIG. 1 represents an example of an information processing device that manages and searches for parts information in electronic circuit designs. With respect to a plurality of sets of previous parts selection data (search logs) of the designer, based on the degree of concordance of the specifications of the parts and based on the reference records of the price information of the parts, the information processing device 100 determines whether or not the parts selection is performed to deal with the EMS or to deal with the EOL issue; and records the determination result in the parts selection data. When the designer selects a part, if the EMS represents the condition for selection, then the information processing device 100 performs a similarity search with respect to the sets of parts selection data for which the determination result indicates the EMS. Similarly, if the EOL represents the condition for selection, then the information processing device 100 performs a similarity search with respect to the sets of parts selection data for which the determination result indicates the EOL issue. As a result, the information processing device 100 enables achieving enhancement in the parts recommendation accuracy.

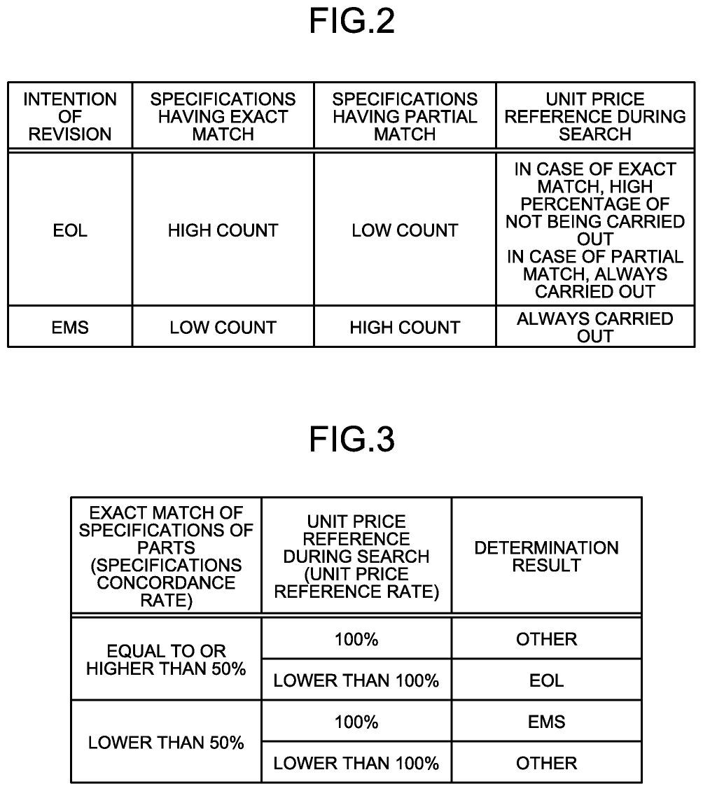

Explained below with reference to FIGS. 2 and 3 are the characteristics and the determination criteria of the information appearing in search logs. FIG. 2 is a diagram illustrating an example of the characteristics of the information appearing in search logs. As illustrated in FIG. 2, the information appearing in search logs, that is, the information appearing in parts information system logs has distinguishing differences depending on whether the intention of revision is to deal with the EOL issue or to deal with the EMS. For example, in a log for a particular target part for replacement, if the intention of revision is to deal with the EOL issue, then the log is characterized by a large number of specifications having an exact match and only a small number of specifications having a partial match. Moreover, if the intention of revision is to deal with the EOL issue, the unit price reference during the search is characterized by not being carried out at a high percentage when there is an exact match of specifications and is characterized by being always carried out when there is a partial match. Meanwhile, if the task of cost cutting is to be performed in addition, then the unit price of the parts is also referred to even if the intention of revision is to deal with the EOL issue.

On the other hand, when the intention of revision is to deal with the EMS, the log is characterized by only a small number of specifications having an exact match and a large number of specifications having a partial match. Moreover, when the intention of revision is to deal with the EMS, the unit price reference is characterized by always being carried out during the search. In the embodiment, using such characteristics and based on a specifications concordance rate and the unit price reference rate, the intention of revision is determined, that is, it is determined whether the design revision deals with the EOL issue or deals with the EMS.

FIG. 3 is a diagram illustrating an example of the determination criteria. As illustrated in FIG. 3, with respect to the characteristics of the information appearing in the search log explained with reference to FIG. 2, two items are used as the determination criteria with respect to the search log obtained in a single session of the search operation performed by the designer. Herein, a single session is set to, for example, one hour on account of the fact that a standard session finishes within one hour. The first item of the determination criteria indicates the percentage of a perfect match of the specifications of parts (i.e., indicates the specifications concordance rate). That is, in the determination of whether to deal with the EOL issue or the EMS, the percentage of parts having an exact match with a particular target part for replacement as well as the percentage of parts having a partial match with the particular target part for replacement is calculated. The second item of the determination criteria indicates the rate of unit price reference during a search (i.e., indicates the unit price reference rate).

If the items of the determination criteria indicate that the specifications concordance rate is equal to or higher than 50% and that the unit price reference rate is lower than 100%, then the determination result is assumed to indicate the EOL issue. Moreover, if the items of the determination criteria indicate that the specifications concordance rate is lower than 50% and that the unit price reference rate is equal to 100%, then the determination result is assumed to indicate the EMS. Furthermore, if the items of the determination criteria either indicate that the specifications concordance rate is equal to or higher than 50% and that the unit price reference rate is equal to 100% or indicate that the specifications concordance rate is lower than 50% and that the unit price reference rate is lower than 100%, then the determination result is assumed to indicate some other issue.

Given below is the explanation of a configuration of the information processing device 100. As illustrated in FIG. 1, the information processing device 100 includes a communicating unit 110, a display unit 111, an operating unit 112, a memory unit 120, and a control unit 130. Meanwhile, the information processing device 100 may include various functional units of a known computer besides including the functional units illustrated in FIG. 1. For example, the information processing device 100 may include functional units such as various input devices and sound output devices.

The communicating unit 110 is implemented using, for example, a network interface card (NIC). The communicating unit 110 is an interface that is connected to other information processing devices in a wired manner or a wireless manner via a network (not illustrated), and that controls the communication of information with other information processing devices. For example, the communicating unit 110 receives parts information and parts information system logs (search logs) from other information processing devices. Moreover, the communicating unit 110 sends extraction logs and attribute tables to other information processing devices.

The display unit 111 is a display device meant for displaying a variety of information. For example, the display unit 111 is implemented using a liquid crystal display as the display device. The display unit 111 displays various screens such as display screens that are input from the control unit 130.

The operating unit 112 is an input device for receiving various operations from the user of the information processing device 100. For example, the operating unit 112 is implemented using a keyboard and a mouse as the input devices. The operating unit 112 outputs the user-input operations as operation information to the control unit 130. Meanwhile, the operating unit 112 can be implemented using a touch-sensitive panel as an input device. Moreover, the display device of the display unit 111 and the input devices of the operating unit 112 can be configured in an integrated manner.

The memory unit 120 is implemented using, for example, a semiconductor memory device such as a random access memory (RAM) or a flash memory; or a memory device such as a hard disk or an optical disk. The memory unit 120 includes a parts information storing unit 121, a system log storing unit 122, an extraction log storing unit 123, and an attribute table storing unit 124. Moreover, the memory unit 120 is used to store the information used in the processing performed by the control unit 130.

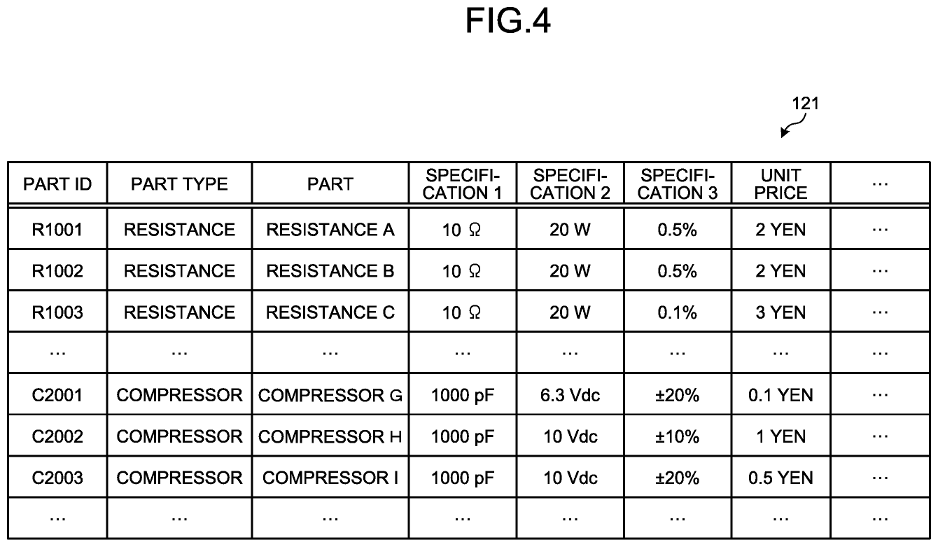

The parts information storing unit 121 is used to store the information about the parts used in the electronic circuit design. FIG. 4 is a diagram illustrating an example of the parts information storing unit. As illustrated in FIG. 4, the parts information storing unit 121 is used to store the following items: “part identifier (ID)”, “part type”, “part”, “specification 1”, “specification 2”, “specification 3”, and “unit price”.

The “part ID” item includes identifiers enabling identification of parts. The “part type” item represents information indicating the types of parts such as resistance and compressor. The “part” item represents information indicating the names and the model numbers of the parts. The items “specification 1” to “specification 3” represent information indicating the representative specifications of the parts. In the following explanation, the term “representative specifications” also implies all specifications in a collective manner. The “unit price” item represents information indicating the unit prices of the parts.

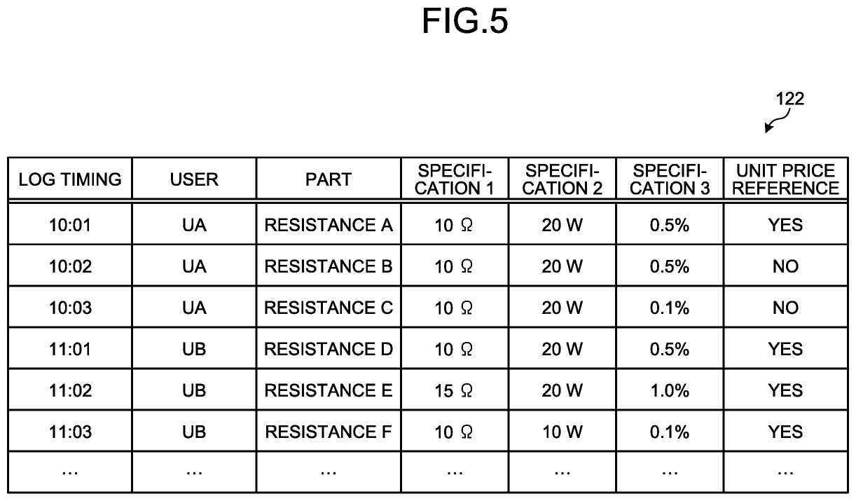

Returning to the explanation with reference to FIG. 1, the system log storing unit 122 is used to store, for example, parts information system logs (hereinafter, also called system logs) that were searched in a parts information system by a plurality of designers for the purpose of selecting the parts at the time of carrying out design revision. Thus, the system logs are an example of search logs representing a plurality of sets of parts selection data obtained in the past. FIG. 5 is a diagram illustrating an example of the system log storing unit. As illustrated in FIG. 5, the system log storing unit 122 includes the following items: “log timing”, “user”, “part”, “specification 1”, “specification 2”, “specification 3”, and “unit price reference”.

The “log timing” item represents information indicating the timings of searching for a part and recording a log. The “user” item represents information indicating the users who performed a search for a part. The “part” item represents information indicating the target parts for search. The “specification 1” item to the “specification 3” item represent information indicating the representative specifications of the parts. The “unit price reference” item represents information indicating whether or not the unit price was referred to at the time of searching for the parts.

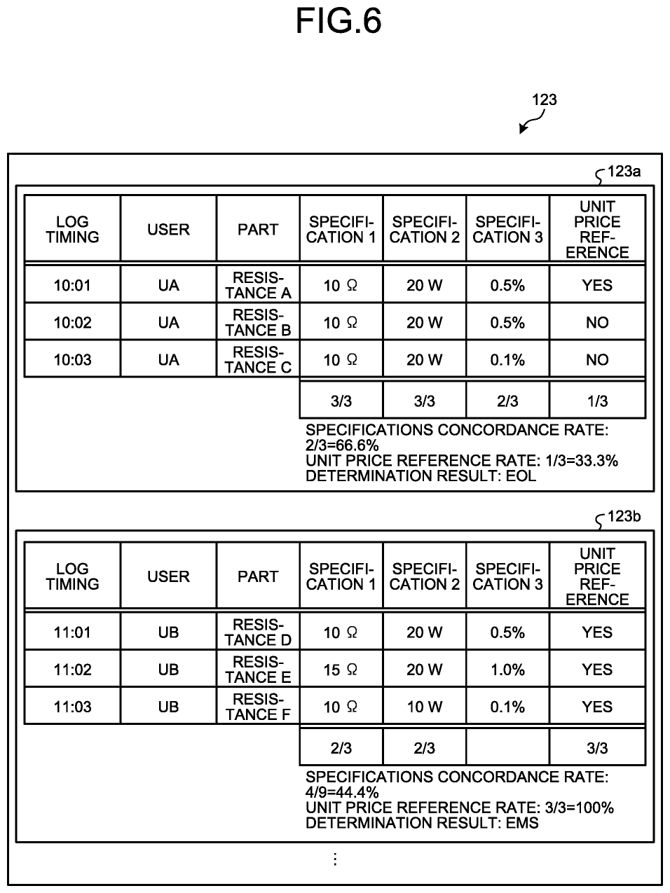

Returning to the explanation with reference to FIG. 1, the extraction log storing unit 123 is used to store the log of each session of each user as extracted from the system log. FIG. 6 is a diagram illustrating an example of the extraction log storing unit. As illustrated in FIG. 6, the extraction log storing unit 123 is used to store the extraction log, the specifications concordance rate, the unit price reference rate, and the determination result in a corresponding manner on a session-by-session basis.

In the example illustrated in FIG. 6, a log 123a includes the following: the extraction log regarding a particular session of a user UA; the specifications concordance rate in the extraction log; the unit price reference rate; and the determination result. In the log 123a, the specifications concordance rate is calculated by multiplying the concordance rate of each of the “specification 1” to the “specification 3”. Thus, the specifications concordance rate becomes equal to ((3/3)×(3/3)×(2/3))=(2/3)=66.6%. Moreover, of the three sets of log data, since there is one set of log data in which the unit price reference column has “yes” written in the unit price reference rate, the unit price reference rate becomes equal to (1/3)=33.3%. The determination result implies that the determination result of the design revision, which was carried out based on the specifications concordance rate and the unit price reference rate, indicates the EOL issue. In an identical manner, a log 123b includes the following: the extraction log regarding a particular session of a user UB; the specifications concordance rate in the extraction log; the unit price reference rate; and the determination result. Meanwhile, regarding the specifications having no match thereto, such specifications can be excluded from the calculation of the specifications concordance rate.

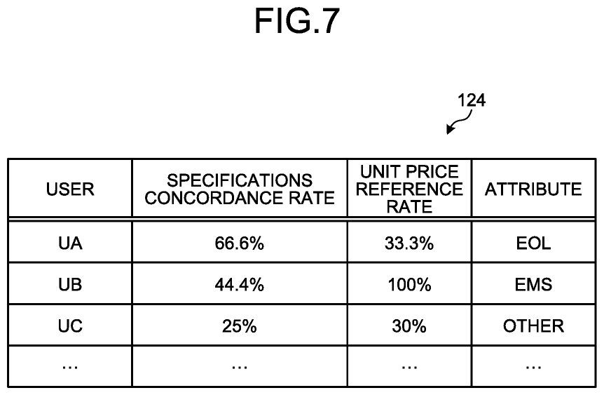

Returning to the explanation with reference to FIG. 1, the attribute table storing unit 124 is used to store the specifications concordance rate, the unit price reference rate, and the attributes in a corresponding manner on a user-by-user basis. FIG. 7 is a diagram illustrating an example of the attribute table storing unit. As illustrated in FIG. 7, the attribute table storing unit 124 includes the following items: “user”, “specifications concordance rate”, “unit price reference rate”, and “attribute”.

The “user” item represents information indicating the users who have searched for the parts in the past. The “specifications concordance rate” item represents information indicating the concordance ratios of the specifications in the parts searched on a session-by-session basis. The “unit price reference rate” item represents information indicating the rate of unit price reference. The “attribute” item represents information indicating the determination results of the design revision regarding the users who searched for the parts. That is, in the attribute table storing unit 124, the specifications concordance rate, the unit price reference rate, and the attribute are stored for each user and each session stored in the extraction log storing unit 123.

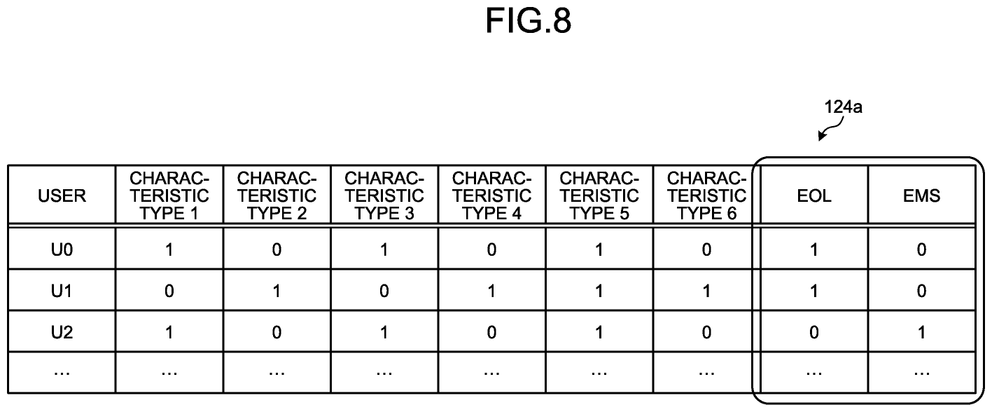

FIG. 8 is a diagram illustrating another example of the attribute table storing unit. An attribute table storing unit 124a illustrated in FIG. 8 represents an example of generalization of the attribute table storing unit 124. The attribute table storing unit 124a includes the following items: “user”; “characteristic type 1” to “characteristic type 6”; “EOL”; and “EMS”.

The “user” item represents information indicating the users who has searched for the parts in the past. The “characteristic type 1” item to the “characteristic type 6” item correspond to the “specifications concordance rate” item and the “unit price reference rate” stored in the attribute table storing unit 124. The “EOL” item represents information indicating whether or not the determination results of the design revision carried out by the users imply the EOL issue. The “EMS” item represents information indicating whether or not the determination results of the design revision carried out by the users imply the EMS. In the attribute table storing unit 124a, regarding the “characteristic type 1” item to the “characteristic type 6” item, the “EOL” item, and the “EMS” item; the applicable positions have a flag “1” set therein and the non-applicable positions have a flag “0” set therein. Meanwhile, the value of each item is not limited to be expressed using the flag “0” or the flag “1”, and alternatively can be expressed using, for example, the average access count taken on a user-by-user basis.

Returning to the explanation with reference to FIG. 1, the control unit 130 is implemented when, for example, a central processing unit (CPU) or a micro processing unit (MPU) executes a computer program, which is stored in an internal memory device, using a random access memory (RAM) as the work area. Alternatively, for example, the control unit 130 can be implemented using an integrated circuit such as an application specific integrated circuit (ASIC) or a field programmable gate array (FPGA). The control unit 130 includes a receiving unit 131, a determining unit 132, a searching unit 133, and an output control unit 134; and implements or executes the functions and the actions of information processing as described below. Meanwhile, the internal configuration of the control unit 130 is not limited to the configuration illustrated in FIG. 1. That is, as long as it is possible to perform the information processing described below, any other configuration can also be adapted.

The receiving unit 131 performs an attribute table generation operation when, for example, an attribute table generation instruction is issued by the administrator of the information processing device 100. The receiving unit 131 refers to the system log storing unit 122; extracts the users from the system logs; and generates a user list. Then, the receiving unit 131 outputs the generated user list to the determining unit 132.

Moreover, the receiving unit 131 receives the login performed by users. Upon receiving a login, the receiving unit 131 refers to the attribute table storing unit 124 and obtains the attribute of the user who logged in. Moreover, for example, the receiving unit 131 receives selection of a target part for replacement from a parts search screen. Then, the receiving unit 131 outputs the attribute of the logged-in user and the target part for replacement to the searching unit 133.

Furthermore, upon receiving input of the information that is already output from the output control unit 134, the receiving unit 131 determines whether or not the logged-in user is going to log out. If it is determined that the logged-in user is not going to log out, then the receiving unit 131 waits for the selection of the next target part for replacement. When the receiving unit 131 determines that the logged-in user is going to log out, the search operation is ended.

The determining unit 132 receives input of the user list from the receiving unit 131 and performs the following operations for all users listed in the user list: extraction of the session logs; calculation of the specifications concordance rate and the unit price reference rate; and determination of the selection of parts for design revision.

Moreover, when the user list is received from the receiving unit 131, the determining unit 132 determines whether or not the operations for all users listed in the user list are completed. If it is determined that the operations for all users listed in the user list are completed, then the determining unit 132 outputs a message to the display unit 111 for notifying that the generation of the attribute table is completed, and ends the attribute table generation operation.

Meanwhile, if it is determined that the operations are not yet completed for all users, then the determining unit 132 selects one user from the user list. After selecting one user, the determining unit 132 refers to the system log storing unit 122 and extracts the logs of the sessions of the selected user from the system logs.

Upon extracting the logs of the sessions, the determining unit 132 determines whether or not all sessions have been processed. If it is determined that all sessions have been processed, then the determining unit 132 proceeds to the operations for the next user. When it is determined that all sessions are not yet processed, the determining unit 132 selects one session. Then, the determining unit 132 stores the log of the selected session as the extraction log in the extraction log storing unit 123. Once the extraction log is stored in the extraction log storing unit 123, the determining unit 132 performs a calculation operation.

In the calculation operation, firstly, the determining unit 132 determines whether or not all specifications have been processed regarding the extraction log. If it is determined that all specifications are not yet processed, then the determining unit 132 selects one specification from all specifications of the extraction log. Then, regarding the selected specification, the determining unit 132 calculates the concordance rate according to the count of the most-frequently-appearing specification value and the number of parts. Subsequently, the determining unit 132 stores the calculated concordance rate in the corresponding extraction log stored in the extraction log storing unit 123. Once the calculated concordance rate is stored, the determining unit 132 again determines whether or not all specifications have been processed.

When it is determined that all specifications have been processed, the determining unit 132 refers to the extraction log storing unit 123 and calculates the specifications concordance rate from the concordance rate of each specification. For example, the determining unit 132 multiplies the concordance rate of each specification, and calculates the specifications concordance rate. Moreover, the determining unit 132 refers to the extraction log storing unit 123 and calculates the unit price reference rate depending on the presence or absence of the unit price reference. Then, the determining unit 132 stores the specifications concordance rate and the unit price reference rate in the corresponding extraction log stored in the extraction log storing unit 123, and ends the calculation operation.

When the calculation operation is ended, the determining unit 132 refers to the extraction log storing unit 123 and generates an attribute table that includes the specifications concordance rate and the unit price reference rate. That is, the determining unit 132 associates, from the attribute table, the specifications concordance rate and the unit price reference rate to the user. At that time, the attribute column in the attribute table is left empty. The determining unit 132 stores the generated attribute table in the attribute table storing unit 124.

Once the attribute table is stored in the attribute table storing unit 124, the determining unit 132 performs a determination operation. In the determination operation, the determining unit 132 determines whether or not the operations for all users are completed. When the operations for all users are completed, the determining unit 132 ends the determination operation.

If it is determined that the operations for all users are not yet completed, then the determining unit 132 selects one user. Subsequently, regarding the selected user, the determining unit 132 refers to the extraction log storing unit 123 and determines whether or not the specifications concordance rate is equal to or higher than 50%. If it is determined that the specifications concordance rate is not equal to or higher than 50%, then the determining unit 132 determines whether or not the unit price reference rate is equal to 100%. If it is determined that the unit price reference rate is equal to 100%, then the determining unit 132 sets, regarding the selected user, “EMS” in the attribute column of the attribute table stored in the attribute table storing unit 124. However, if it is determined that the unit price reference rate is not equal to 100%, then the determining unit 132 sets, regarding the selected user, “other” in the attribute column of the attribute table stored in the attribute table storing unit 124.

In the determination about whether the specifications concordance rate is equal to or higher than 50%, if it is determined that the specifications concordance rate is equal to or higher than 50%, the determining unit 132 determines whether or not the unit price reference rate is equal to or higher than 50%. If it is determined that the unit price reference rate is equal to or higher than 50%; then the determining unit 132 sets, regarding the selected user, “other” in the attribute column of the attribute table stored in the attribute table storing unit 124. On the other hand, if it is determined that the unit price reference rate is not equal to or higher than 50%; then the determining unit 132 sets, regarding the selected user, “EOL” in the attribute column of the attribute table stored in the attribute table storing unit 124. Once the attribute column is set, the determining unit 132 again determines whether or not the operations for all users are completed.

In other words, with respect to a plurality of previous sets of parts selection data of the designer, based on the degree of concordance of the specifications of the parts and based on the reference record of the price information of each part, the determining unit 132 determines whether the selection of that part is meant to deal with the EMS or with the EOL issue, and records the determination result in the parts selection data. Moreover, when the degree of concordance of the specifications of the parts (i.e., the specifications concordance rate) is lower than a predetermined value and when the reference rate in the reference record of the price information of each part (i.e., the unit price reference rate) is equal to 100%, the determining unit 132 determines that the selection of the concerned part is meant to deal with the EMS. On the other hand, when the degree of concordance of the specifications of the parts is equal to or higher than the predetermined value and when the reference rate is lower than 100%, the determining unit 132 determines that the selection of the concerned part is meant to deal with the EOL issue. Moreover, of a plurality of previous sets of parts selection data, for each session corresponding to a single parts selection operation, the determining unit 132 determines whether the selection of the part is meant to deal with the EMS or with the EOL issue. Furthermore, the determining unit 132 generates a table in which the following information is held in a corresponding manner: the designer who performed the parts selection operation once; the degree of concordance of the specifications of the parts and the reference record of the price information of each part; and the determination result.

The searching unit 133 receives input of the logged-in user and the target part for replacement from the receiving unit 131, and determines whether or not the attribute of the logged-in user indicates “EMS”. If it is determined that the attribute of the logged-in user indicates “EMS”, then the searching unit 133 refers to the extraction log storing unit 123 and the attribute table storing unit 124, and performs a similarity search with respect to the extraction logs of the users having the attribute “EMS”. The searching unit 133 obtains the candidate parts for replacement based on the similarity search and obtains the users corresponding to the extraction logs in which the candidate parts for replacement are included. Then, the searching unit 133 treats the obtained users as similar users, and outputs the similar users and the candidate parts for replacement to the output control unit 134. Herein, a similar user implies, in other words, a user who, from among the users specified in the attribute table having the attribute identical to the attribute of the logged-in user, corresponds to the extraction log in which a candidate part for replacement is included.

Meanwhile, when it is determined that the attribute of the logged-in user does not indicate “EMS”, the searching unit 133 determines whether or not the attribute of the logged-in user indicates “EOL”. If it is determined that the attribute of the logged-in user indicates “EOL”, then the searching unit 133 refers to the extraction log storing unit 123 and the attribute table storing unit 124, and performs a similarity search with respect to the extraction logs of the users having the attribute “EOL”. The searching unit 133 obtains the candidate parts for replacement based on the result of the similarity search and obtains the users corresponding to the extraction logs in which the candidate parts for replacement are included. The searching unit 133 treats the obtained users as similar users, and outputs the similar users and the candidate parts for replacement to the output control unit 134.

If it is determined that the attribute of the logged-in user does not indicate “EOL”, then the searching unit 133 refers to the extraction log storing unit 123 and the attribute table storing unit 124, and performs a similarity search with respect to the extraction logs of the users having the attribute “other”. The searching unit 133 obtains the candidate parts for replacement based on the result of the similarity search and obtains the users corresponding to the extraction logs in which the candidate parts for replacement are included. The searching unit 133 obtains the candidate parts for replacement based on the result of the similarity search and obtains the users corresponding to the extraction logs in which the candidate parts for replacement are included. The searching unit 133 treats the obtained users as similar users, and outputs the similar users and the candidate parts for replacement to the output control unit 134.

In other words, when the designer (the logged-in user) selects a part, if the condition for selection (i.e., the attribute of the logged-in user) is “EMS”, then the searching unit 133 performs a similarity search with respect to the parts selection data (the extraction logs) for which the determination result indicates the EMS. On the other hand, if the condition for selection is “EOL”, then the searching unit 133 performs a similarity search with respect to the parts selection data for which the determination result indicates the EOL. Moreover, the searching unit 133 refers to the generated table, and determines whether the attribute of the designer who selected the part indicates “EMS” or “EOL”. If the attribute of the designer indicates “EMS”, then the searching unit 133 performs a similarity search with respect to the parts selection data for which the determination result in the session indicates “EMS”. If the attribute of the designer indicates “EOL”, the searching unit 133 performs a similarity search with respect to the parts selection data for which the determination result in the session indicates the EOL issue.

The output control unit 134 receives input of the similar users and the candidate parts for replacement from the searching unit 133; and, for example, displays the similar users and the candidate parts for replacement in the part search screen. After displaying the similar users and the candidate parts for replacement, the output control unit 134 outputs the output notification information to the receiving unit 131.

That is, the output control unit 134 outputs one or more sets of information from among the information about the candidate parts for replacement based on the result of similarity search and the information about the designers corresponding to such parts selection data which contains the candidate parts for replacement and in which the attribute of the designers performing parts selection matches with the determination result of the table.

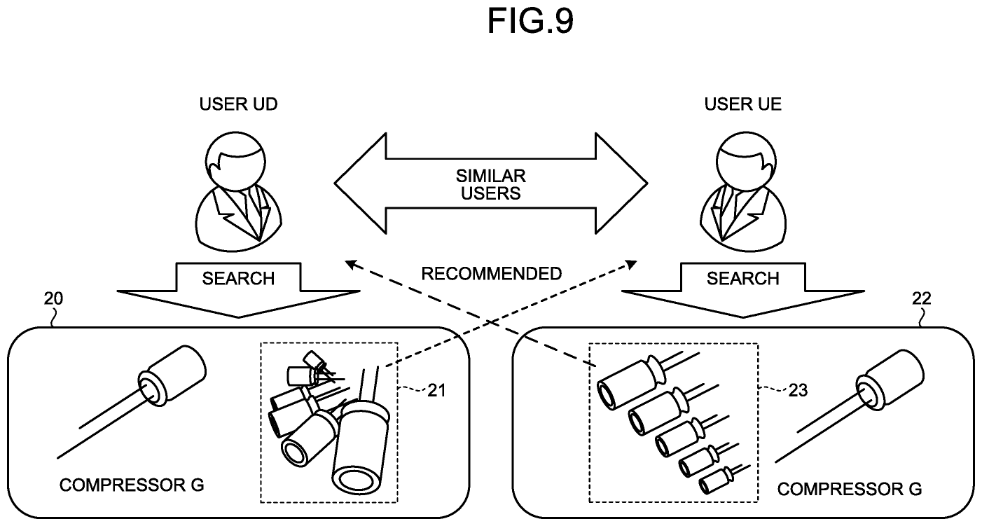

Explained below with reference to FIGS. 9 to 11 is an example of the display of collaborative filtering and the candidate parts for replacement. FIG. 9 is a diagram illustrating an example of recommendation based on collaborative filtering. In the example illustrated in FIG. 9, a search result 20 of a user UD includes a compressor G and includes a parts group 21 having similar specifications to the compressor G. Moreover, a search result 22 of a user UE includes the compressor G and includes a parts group 23 having similar specifications to the compressor G. The parts group 21 represents a part group not searched by the user UE. On the other hand, the parts group 23 represents a part group not searched by the user UD. Since the compressor G representing the same part is included in both search results, it is determined that the users UD and UE are similar users. In the collaborative filtering, the parts group 23 is recommended to the user UD, and the parts group 21 is recommended to the user UE.

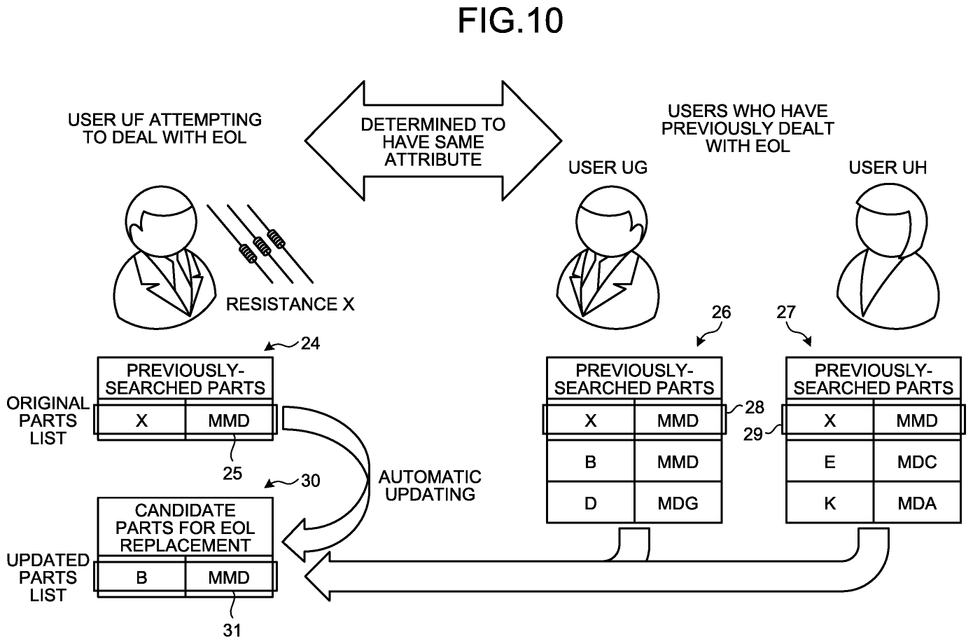

FIG. 10 is a diagram illustrating an example of updating a parts list dealing with the EOL issue. In the example illustrated in FIG. 10, as an example of the display of the candidate parts for replacement, the parts list dealing with the EOL issue is updated. A user UF who intends to deal with the EOL issue is a designer and performs a search focusing on the interchangeability of the parts. Firstly, from previously-searched parts 24 representing the original parts list, the user UF selects an item 25 corresponding to a resistance X. Herein, in the item 25, “MMD” is assumed to be the series name of the resistance X. The searching unit 133 determines that users UG and UH, who have dealt with the EOL issue in the past, and the user UF are matching as far as dealing with the EOL issue is concerned. That is, the searching unit 133 determines that the users UG and UH have the same attribute as the user UF. Thus, when the searching unit 133 performs a similarity search with respect to previously-searched parts 26 and 27 that represent extraction logs of the users UG and UH, respectively; items 28 and 29 corresponding to the resistance X are retrieved along with a resistance B that too belongs to the same series “MMD”. Since the search is meant to deal with the EOL issue, that is, meant to focus on the specifications; the searching unit 133 treats the resistance B, which is of the same series having similar specifications, as the candidate part for replacement; and outputs the information about the resistance B to the output control unit 134 for updating the item 25. That is, in candidate parts 30 for EOL replacement representing the parts list obtained by updating the previously-searched parts 24, the searching unit 133 and the output control unit 134 update the item 25 corresponding to the resistance X to an item 31 corresponding to the item B. As a result, the information processing device 100 becomes able to recommend the resistance B, which is suitable to deal with the EOL issue of the resistance X, to the user UF.

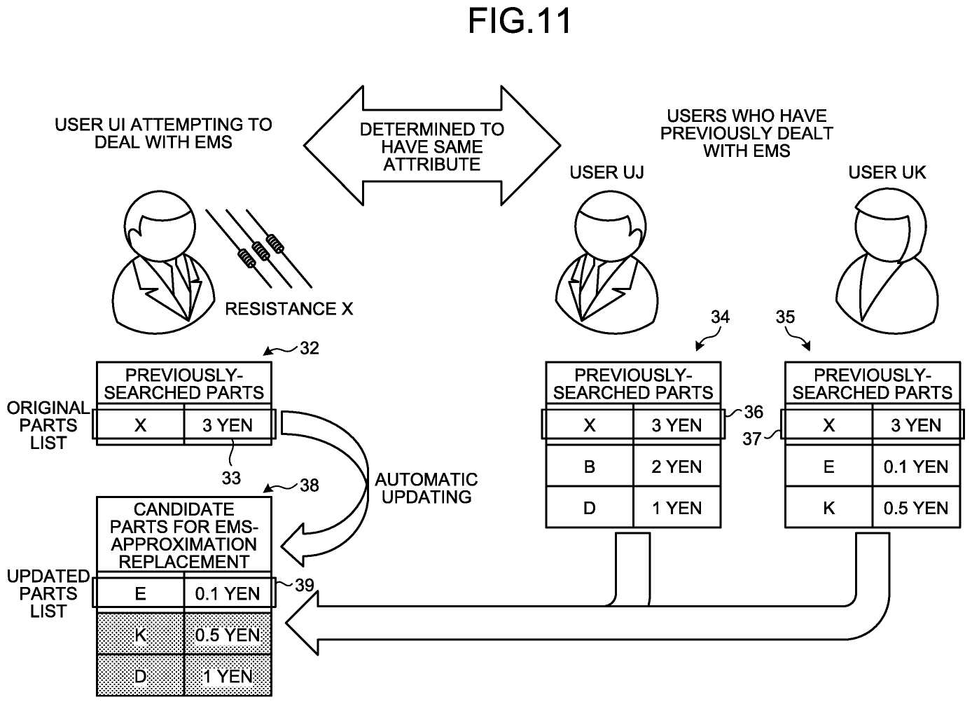

FIG. 11 is a diagram illustrating an example of updating a parts list dealing with the EMS. In the example illustrated in FIG. 11, as an example of the display of the candidate parts for replacement, the parts list dealing with the EMS is updated. A user UI who intends to deal with the EMS is, for example, the person in charge of the purchase department, and performs a search focusing on the unit price of the parts. Firstly, from previously-searched parts 32 representing the original parts list, the user UI selects an item 33 corresponding to the resistance X. In the item 33, “3 yen” is assumed to be the unit price of the resistance X. The searching unit 133 determines that users UJ and UK, who have dealt with the EMS in the past, and the user UI are matching as far as dealing with the EMS is concerned. That is, the searching unit 133 determines that the users UJ and UK have the same attribute as the user UI. Thus, when the searching unit 133 performs a similarity search with respect to previously-searched parts 34 and 35 that represent extraction logs of the users UJ and UK, respectively; items 36 and 37 corresponding to the resistance X are retrieved along with a resistance E that has the cheapest unit price. Since the search is meant to deal with the EMS, that is, meant to focus on the unit price, the searching unit 133 treats the resistance E, which simply has the cheapest unit price, as the candidate part for replacement; and outputs the information about the resistance E to the output control unit 134 for updating the item 33. That is, in candidate parts 38 for EMS-approximation replacement representing the parts list obtained by updating the previously-searched parts 32, the searching unit 133 and the output control unit 134 update the item 33 corresponding to the resistance X to an item 39 corresponding to the item E. As a result, the information processing device 100 becomes able to recommend the resistance E, which is suitable to deal with the EMS regarding the resistance X, to the user UI.

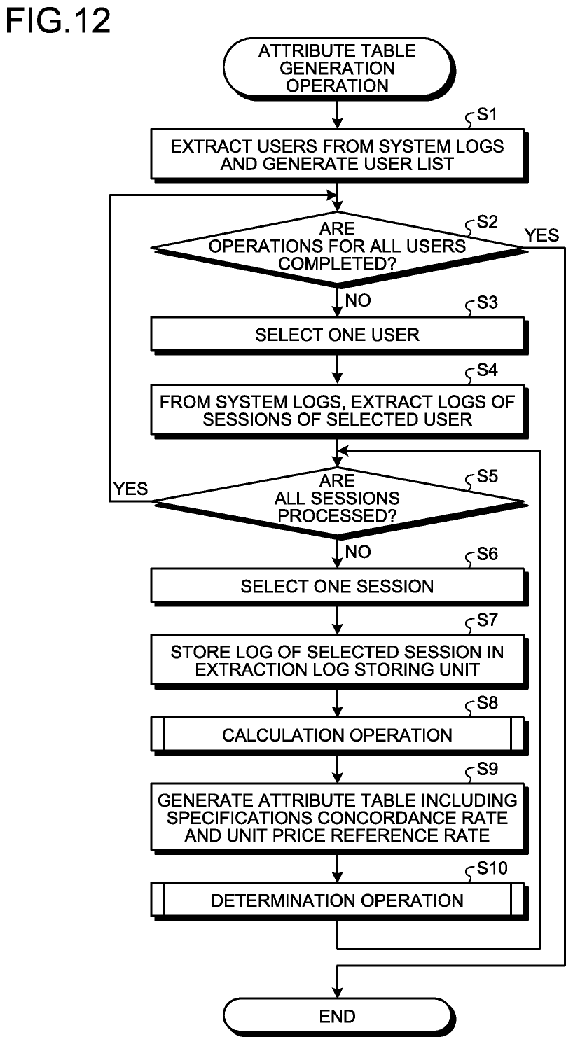

Given below is the explanation of the operations performed by the information processing device 100 according to the embodiment. Firstly, the explanation is given about the attribute table generation operation. FIG. 12 is a flowchart for explaining an example of the attribute table generation operation according to the embodiment.

For example, when an attribute table generation instruction is issued by the administrator of the information processing device 100, the receiving unit 131 refers to the system log storing unit 122 and generates a user list by extracting users from the system logs (Step S1). Then, the receiving unit 131 outputs the user list to the determining unit 132.

Upon receiving the user list from the receiving unit 131, the determining unit 132 determines whether or not the operations for all users are completed (Step S2). If it is determined that the operations for all users are not yet completed (No at Step S2), then the determining unit selects one user from the user list (Step S3). After selecting one user, the determining unit 132 refers to the system log storing unit 122, and extracts the logs of the sessions of the selected user from the system logs (Step S4).

After extracting the logs of the sessions, the determining unit 132 determines whether or not all sessions have been processed (Step S5). If it is determined that all sessions are not yet processed (No at Step S5), then the determining unit 132 selects one session (Step S6). Subsequently, the determining unit 132 stores the log of the selected session as the extracted log in the extraction log storing unit 123 (Step S7). After storing the extraction log in the extraction log storing unit 123, the determining unit 132 performs the calculation operation (Step S8).

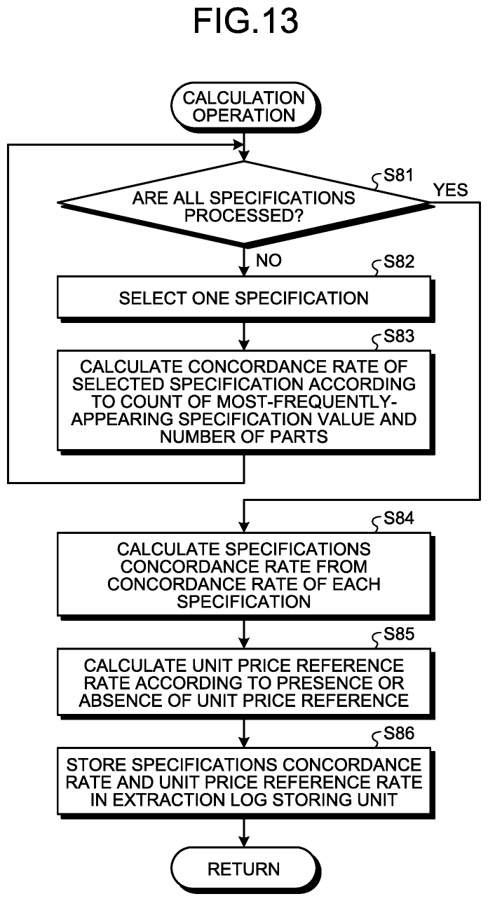

Explained below with reference to FIG. 13 is the calculation operation. FIG. 13 is a flowchart for explaining an example of the calculation operation.

The determining unit 132 determines whether or not all specifications have been processed regarding the extraction log (Step S81). If it is determined that all specifications are not yet processed (No at Step S81), then the determining unit 132 selects one specification from all specifications in the extraction log (Step S82). Subsequently, regarding the selected specification, the determining unit 132 calculates the concordance rate according to the count of the most-frequently-appearing specification value and the number of parts (Step S83). Then, the determining unit 132 stores the calculated concordance rate in the corresponding extraction log in the extraction log storing unit 123. Once the calculated concordance rate is stored, the system control returns to Step S81.

When it is determined that all specifications have been processed (Yes at Step S81), the determining unit 132 refers to the extraction log storing unit 123 and calculates the specifications concordance rate from the concordance rate of each specification (Step S84). Moreover, the determining unit 132 refers to the extraction log storing unit 123 and calculates the unit price reference rate according to the presence or absence of the unit price reference (Step S85). Then, the determining unit 132 stores the specifications concordance rate and the unit price reference rate in the corresponding extraction log in the extraction log storing unit 123 (Step S86), and the system control returns to the original operations. As a result, the determining unit 132 becomes able to calculate the specifications concordance rate and the unit price reference rate for each user and for each session.

Returning to the explanation with reference to FIG. 12, when the calculation operation is over, the determining unit 132 refers to the extraction log storing unit 123 and generates an attribute table that includes the specifications concordance rate and the unit price reference rate (Step S9). Then, the determining unit 132 stores the attribute table in the attribute table storing unit 124, and performs the determination operation (Step S10).

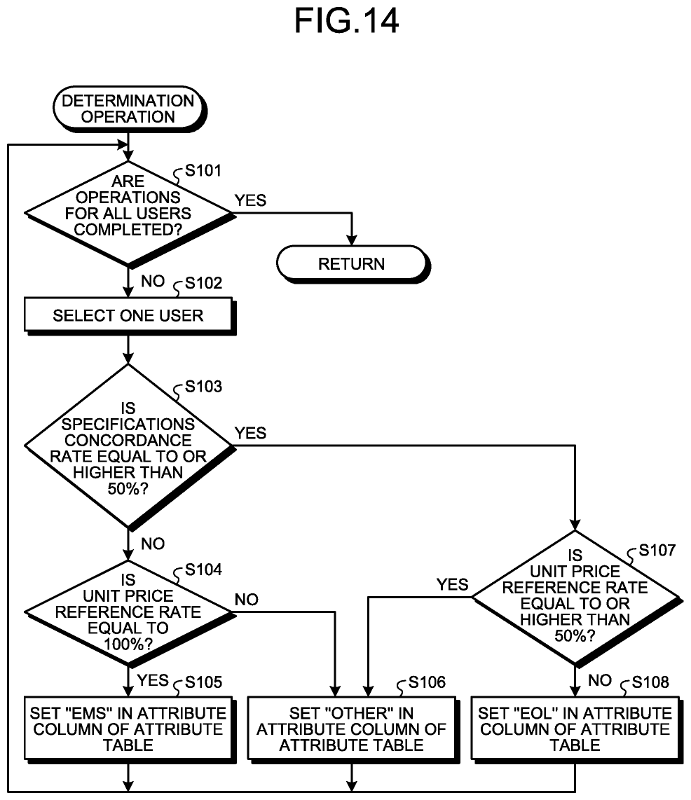

Explained below with reference to FIG. 14 is the determination operation. FIG. 14 is a flowchart for explaining an example of the determination operation.

In the determination operation, the determining unit 132 determines whether or not the operations for all users are completed (Step S101). If it is determined that the operations for all users are not yet completed (No at Step S101), then the determining unit 132 selects one user (Step S102). Then, regarding the selected user, the determining unit 132 refers to the extraction log storing unit 123 and determines whether or not the specifications concordance rate is equal to or higher than 50% (Step S103).

If it is determined that the specifications concordance rate is not equal to or higher than 50% (No at Step S103), then the determining unit 132 determines whether or not the unit price reference rate is equal to 100% (Step S104). If it is determined that the unit price reference rate is equal to 100% (Yes at Step S104), then the determining unit 132 sets, regarding the selected user, “EMS” in the attribute column of the attribute table stored in the attribute table storing unit 124 (Step S105), and the system control returns to Step S101. However, if it is determined that the unit price reference rate is not equal to 100% (No at Step S104), then the determining unit 132 sets, regarding the selected user, “other” in the attribute column of the attribute table stored in the attribute table storing unit 124 (Step S106), and the system control returns to Step S101.

Meanwhile, at Step S103, if it is determined that the specifications concordance rate is equal to or higher than 50% (Yes at Step S103), then the determining unit 132 determines whether or not the unit price reference rate is equal to or higher than 50% (Step S107). If it is determined that the unit price reference rate is equal to or higher than 50% (Yes at Step S107), then the determining unit 132 sets, regarding the selected user, “other” in the attribute column of the attribute table stored in the attribute table storing unit 124 (Step S106), and the system control returns to Step S101.

On the other hand, if it is determined that the unit price reference rate is not equal to or higher than 50% (No at Step S107), then the determining unit 132 sets, regarding the selected user, “EOL” in the attribute column of the attribute table stored in the attribute table storing unit 124 (Step S108), and the system control returns to Step S101.

At Step S101, when it is determined that the operations for all users are completed (Yes at Step S101), then the system control returns to the original operations. In this way, the determining unit 132 becomes able to determine whether to deal with the EMS or with the EOL issue in each session of the user.

Returning to the explanation with reference to FIG. 12, when the determination operation is ended, the system control returns to Step S5. Then, at Step S5, if it is determined that all sessions have been processed (Yes at Step S5), the system control returns to Step S2 and the operations for the next user are performed.

At Step S2, when it is determined that the operations for all users are completed (Yes at Step S2), the determining unit 132 outputs a message on the display unit 111 for notifying that the generation of the attribute table is completed, and ends the attribute table generation operation. As a result, with respect to a user who had performed parts selection in the past, the information processing device 100 becomes able to generate an attribute table in which it is determined whether the conditions for selection indicate the EMS or indicate the EOL issue. Moreover, with respect to the session-by-session extraction logs of the user who had performed parts selection in the past, the information processing device 100 becomes able to add the determination result about whether to deal with the EMS or the EOL issue. Furthermore, the information processing device 100 becomes able to extract, from the system logs, the sessions in which the EOL issue was dealt with and the sessions in which the EMS was dealt with. Moreover, with respect to the system logs stored in the past, that is, with respect to the parts search logs, the information processing device 100 becomes able to perform EOL/EMS determination and to generate statistical data having a tag of the determination result attached thereto.

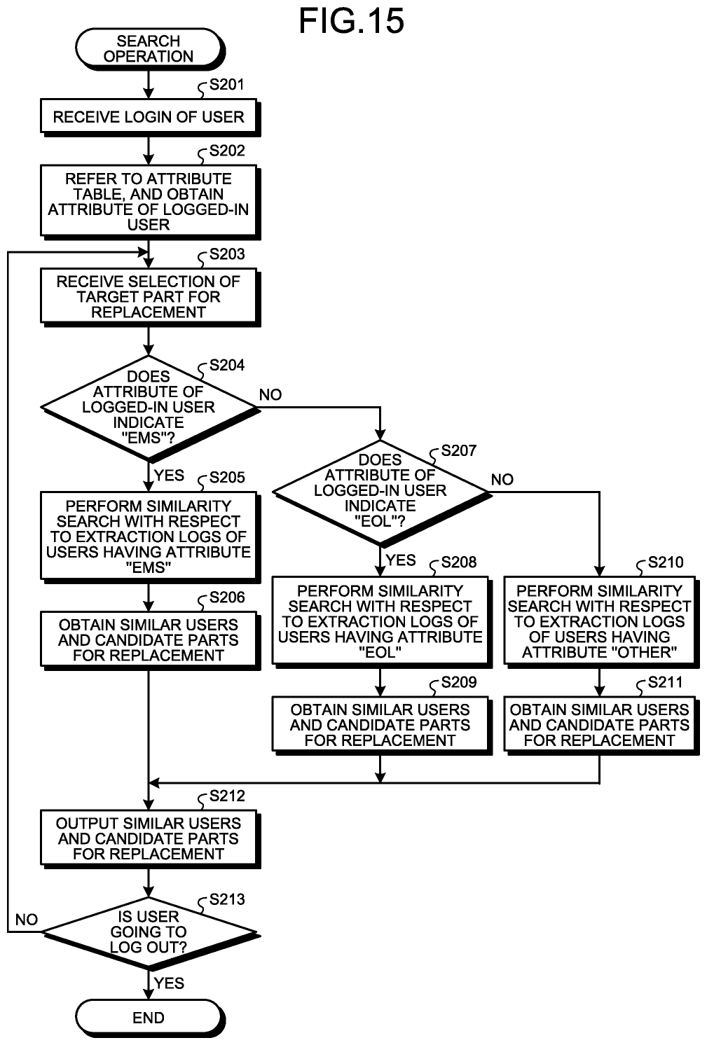

Given below is the explanation of the search operation. FIG. 15 is a flowchart for explaining an example of the search operation according to the embodiment.

The receiving unit 131 receives the login of a user (Step S201), and refers to the attribute table storing unit 124 and obtains the attribute of the logged-in user (Step S202). For example, in the parts search screen, the receiving unit 131 receives the selection of the target part for replacement (Step S203). Then, the receiving unit 131 outputs the attribute of the logged-in user and the target part for replacement to the searching unit 133.

Upon receiving the input of the attribute of the logged-in user and the target part for replacement, the searching unit 133 determines whether or not the attribute of the logged-in user indicates “EMS” (Step S204). If it is determined that the attribute of the logged-in user indicates “EMS” (Yes at Step S204), then the searching unit 133 refers to the extraction log storing unit 123 and the attribute table storing unit 124, and performs a similarity search with respect to the extraction logs of the users having the attribute “EMS” (Step S205). Then, based on the result of the similarity search, the searching unit 133 obtains the similar users and the candidate parts for replacement (Step S206). Subsequently, the searching unit 133 outputs the similar users and the candidate parts for replacement to the output control unit 134.

Meanwhile, if it is determined that the attribute of the logged-in user does not indicate “EMS” (No at Step S204), then the searching unit 133 determines whether or not the attribute of the logged-in user indicates “EOL” (Step S207). If it is determined that the attribute of the logged-in user indicates “EOL” (Yes at Step S207), then the searching unit 133 refers to the extraction log storing unit 123 and the attribute table storing unit 124, and performs a similarity search with respect to the extraction logs of the users having the attribute “EOL” (Step S208). Then, based on the result of the similarity search, the searching unit 133 obtains the similar users and the candidate parts for replacement (Step S209). Subsequently, the searching unit 133 outputs the similar users and the candidate parts for replacement to the output control unit 134.

On the other hand, if it is determined that the attribute of the logged-in user does not indicate “EOL” (No at Step S207), then the searching unit 133 refers to the extraction log storing unit 123 and the attribute table storing unit 124, and performs a similarity search with respect to the extraction logs of the users having the attribute “other” (Step S210). Then, based on the result of the similarity search, the searching unit 133 obtains the similar users and the candidate parts for replacement (Step S211). Subsequently, the searching unit 133 outputs the similar users and the candidate parts for replacement to the output control unit 134.

Upon receiving input of the similar users and the candidate parts for replacement, for example, the output control unit 134 outputs and displays the similar users and the candidate parts for replacement in the parts search screen (Step S212). After displaying the similar users and the candidate parts for replacement, the output control unit 134 outputs output notification information to the receiving unit 131.

Upon receiving input of the output notification information from the output control unit 134, the receiving unit 131 determines whether or not the logged-in user is going to log out (Step S213). If it is determined that the logged-in user is not going to log out (No at Step S213), then the system control returns to Step S203 and the receiving unit 131 waits for the selection of the next target part for replacement. When the receiving unit 131 determines that the logged-in user is going to log out (Yes at Step S213), the search operation is ended. As a result, the information processing device 100 enables achieving enhancement in the parts recommendation accuracy. Moreover, the information processing device 100 enables achieving enhancement in the accuracy of selection of the similar users who have a similar inclination in design revision to the logged-in user.

Meanwhile, in the embodiment described above, based on whether or not the specifications concordance rate is equal to or higher than 50%, it is determined whether or not to deal with the EMS or with the EOL issue. However, that is not the only possible case. For example, depending on the type of a part, the search can be performed only for the parts having an exact match, or the search can be performed for parts always having a non-exact match.

Moreover, in the embodiment described above, the extraction logs are used without applying any conditions thereto. However, that is not the only possible case. Alternatively, for example, with respect to a target part for replacement, the appearance ratio of the exactly-matching specifications can be counted and the appearance ratio of the non-exactly-matching specifications can be counted, and the extraction logs for which the count is equal to or higher than a predetermined value can be used. Herein, the predetermined value can be, for example, the average value with respect all types of parts.

Moreover, in the embodiment described above, regardless of the unit price of the target part for replacement, the threshold value for the specifications concordance rate is set to be constant (at 50%). However, that is not the only possible case. For example, for the parts having the unit price below a predetermined value, the threshold value for the specifications concordance rate can be lowered to 30%, for example.

Furthermore, regarding the attribute of each user in the attribute table, for example, reevaluation can be performed once a month. As a result, even if a user changes from dealing with the EOL issue to dealing with the EMS or changes from dealing with the EMS to dealing with the EOL issue, it becomes possible to hold down a decline in the accuracy.

In this way, with respect to a plurality of sets of previous parts selection data of the designer, based on the degree of concordance of the specifications of the parts and based on the reference records of the price information of the parts, the information processing device 100 determines whether or not the selection of parts is done to deal with the EMS or to deal with the EOL issue; and records the determination result in the parts selection data. When the designer selects a part, if the EMS represents the condition for selection, then the information processing device 100 performs a similarity search with respect to the sets of parts selection data for which the determination result indicates the EMS. Similarly, if the EOL represents the condition for selection, then the information processing device 100 performs a similarity search with respect to the sets of parts selection data for which the determination result indicates the EOL issue. As a result, with respect to the session-by-session extraction logs of the designer who had performed parts selection in the past, the information processing device 100 adds the determination result about whether the selection is done to deal with the EMS or to deal with the EOL issue, thereby enabling achieving enhancement in the parts recommendation accuracy in the parts search.

Meanwhile, when the degree of concordance of the specifications of the parts is lower than a predetermined value and when the reference rate in the reference record of the price information of each part is equal to 100%, the information processing device 100 determines that the selection of the concerned part is meant to deal with the EMS. On the other hand, when the degree of concordance of the specifications of the parts is equal to or higher than the predetermined value and when the reference rate is lower than 100%, the information processing device 100 determines that the selection of the concerned part is meant to deal with the EOL issue. As a result, with respect to the session-by-session extraction logs of the designer who had performed parts selection in the past, the information processing device 100 can add the determination result about whether the selection is done to deal with the EMS or with the EOL issue.

Moreover, of a plurality of previous sets of parts selection data, for each session corresponding to a parts selection operation performed once, the information processing device 100 determines whether the selection of a part is meant to deal with the EMS or with the EOL issue. Furthermore, the information processing device 100 generates a table in which the following information is held in a corresponding manner: the designer who performed the parts selection operation once; the degree of concordance of the specifications of the parts and the reference record of the price information of each part; and the determination result. The information processing device 100 refers to the generated table, and determines whether or not the attribute of the designer who selected the part indicates “EMS” or “EOL”. If the attribute of the designer indicates “EMS”, then the information processing device 100 performs a similarity search with respect to the parts selection data for which the determination result in the session indicates “EMS”. If the attribute of the designer indicates “EOL”, the searching unit 133 performs a similarity search with respect to the parts selection data for which the determination result in the session indicates “EOL”. As a result, the information processing device 100 enables achieving enhancement in the parts recommendation accuracy during the parts search in design revision.

Moreover, the information processing device 100 outputs one or more sets of information from among the information about the candidate parts for replacement based on the result of similarity search and the information about the designers corresponding to such parts selection data which contains the candidate parts for replacement and in which the attribute of the designers performing parts selection matches with the determination result of the table. As a result, the information processing device 100 can refer to the information about the candidate parts for replacement and the information about the designer, and accordingly select the replacement parts in the design revision.

Meanwhile, the constituent elements of the device illustrated in the drawings are merely conceptual, and need not be physically configured as illustrated. The constituent elements, as a whole or in part, can be separated or integrated either functionally or physically based on various types of loads or use conditions. For example, the searching unit 133 and the output control unit 134 can be configured in an integrated manner. Moreover, the operations explained with reference to the drawings are not limited to the sequence explained above, and can be performed in a concurrent manner or in a different manner without causing any contradiction in the operation details.

The various processing functions performed by the devices can be entirely or partially implemented by a CPU (or by a microcomputer such as an MPU or a micro controller unit (MCU)); or can be entirely or partially implemented by computer programs that are analyzed and executed by a CPU (or by a microcomputer such as an MPU or an MCU); or can be entirely or partially implemented as hardware using wired logic.

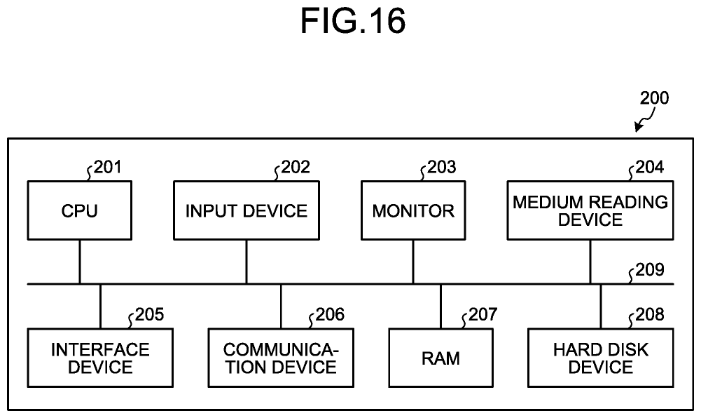

Meanwhile, the various operations explained in the embodiment described above can be implemented when a computer executes a prepared computer program. In that regard, given below is the explanation of an exemplary computer that executes a computer program having identical functions to the functions according to the embodiment described above. FIG. 16 is a diagram illustrating an example of a computer that executes a parts selection program.

As illustrated in FIG. 16, a computer 200 includes a CPU 201 that performs various arithmetic operations; an input device 202 that receives data input; and a monitor 203. Moreover, the computer 200 includes a medium reading device 204 that reads computer programs from a memory medium; an interface device 205 that enables establishing connection with various devices; and a communication device 206 that enables establishing wired connection or wireless connection with other information processing devices. Furthermore, the computer 200 includes a RAM 207 for temporarily storing a variety of information; and a hard disk device 208. Herein, the devices 201 to 208 are connected to each other by a bus 209.

In the hard disk device 208 is stored a parts selection program that has identical functions to the functions of the receiving unit 131, the determining unit 132, the searching unit 133, and the output control unit 134 illustrated in FIG. 1. Moreover, in the hard disk device 208 is stored a variety of data meant for implementing the parts information storing unit 121, the system log storing unit 122, the extraction log storing unit 123, the attribute table storing unit 124, and the parts selection program. The input device 202 receives, for example, input of a variety of information such as operation information from the user of the computer 200. The monitor 203 displays, for example, various screens such as display screens to the user of the computer 200. The interface device 205 is connected to, for example, a printing device. The communication device 206 has identical functions to the functions of the communicating unit 110 illustrated in FIG. 1; is connected to, for example, a network (not illustrated); and communicates a variety of information with other information processing devices.

The CPU 201 reads computer programs stored in the hard disk device 208, loads the computer programs in the RAM 207, and executes them for performing various operations. These computer programs can make the computer 200 function as the receiving unit 131, the determining unit 132, the searching unit 133, and the output control unit 134 illustrated in FIG. 1.

Meanwhile, the parts selection program need not always be stored in the hard disk device 208. Alternatively, for example, the computer 200 can read the parts selection program stored in a memory medium readable by the computer 200, and execute the parts selection program. Examples of the memory medium readable by the computer 200 include a portable memory medium such as a compact disc read only memory (CD-ROM), a digital versatile disc (DVD), or a universal serial bus (USB) memory; a semiconductor memory such as a flash memory; and a hard disk drive. Alternatively, the parts selection program can be stored in a device connected to a public line, the Internet, or a local area network (LAN); and the computer 200 can read the parts selection program from the device and execute it.

In this way, it becomes possible to enhance the parts recommendation accuracy.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device comprising:
a memory; and
a processor coupled to the memory, wherein the processor executes a process comprising:
determining, with respect to a plurality of previous sets of parts selection data of a designer, based on degree of concordance of specifications of parts and based on reference record of price information of each part, whether selection of concerned part is meant to deal with electronics manufacturing service (EMS) or with end of life (EOL) issue, and recording determination result in the parts selection data; and
searching that includes
performing, when the designer performs selection of a part and the EMS represents condition for the selection, similarity search with respect to parts selection data for which the determination result indicates the EMS, and
performing, when the designer performs selection of a part and the EOL issue represents condition for the selection, similarity search with respect to parts selection data for which the determination result indicates the EOL issue.

2. The information processing device according to claim 1, wherein the determining includes
when degree of concordance of specifications of the parts is lower than a predetermined value and when reference rate in reference record of price information of the each part is equal to 100%, determining that the EMS is to be dealt with, and
when the degree of concordance of specifications of the parts is equal to or higher than the predetermined value and when the reference rate is lower than 100%, determining that the EOL issue is to be dealt with.

3. The information processing device according to claim 1, wherein the determining includes
of the plurality of previous sets of parts selection data, for each session corresponding to a parts selection operation performed once, determining whether selection of concerned part is meant to deal with the EMS or with the EOL issue, and generating a table in which following information is held in a corresponding manner: designer who performed the parts selection operation once, degree of concordance of specifications of the parts and reference record of price information of each part, and determination result, and
the searching includes
referring to the generated table,
determining whether or not attribute of designer who performs selection of a part indicates the EMS or the EOL issue,
when attribute of the designer indicates the EMS, performing a similarity search with respect to parts selection data for which determination result in the session indicates the EMS, and
when attribute of the designer indicates the EOL issue, performing a similarity search with respect to parts selection data for which determination result in the session indicates the EOL issue.

4. The information processing device according to claim 3, wherein the process further comprises outputting one or more sets of information from among information about candidate parts for replacement based on result of the similarity search and information about designers corresponding to such parts selection data which contains the candidate parts for replacement and in which attribute of designers performing selection of the parts matches with determination result of the table.

5. A parts selection method, comprising:
determining, with respect to a plurality of previous sets of parts selection data of a designer, based on degree of concordance of specifications of parts and based on reference record of price information of each part, whether selection of concerned part is meant to deal with electronics manufacturing service (EMS) or with end of life (EOL) issue, and recording determination result in the parts selection data, using a processor; and
searching that includes
performing, when the designer performs selection of a part and the EMS represents condition for the selection, similarity search with respect to parts selection data for which the determination result indicates the EMS, using the processor, and
performing, when the designer performs selection of a part and the EOL issue represents condition for the selection, similarity search with respect to parts selection data for which the determination result indicates the EOL issue, using the processor.

6. A non-transitory computer-readable recording medium having stored therein a parts selection program that causes a computer to execute a process comprising:
determining, with respect to a plurality of previous sets of parts selection data of a designer, based on degree of concordance of specifications of parts and based on reference record of price information of each part, whether selection of concerned part is meant to deal with electronics manufacturing service (EMS) or with end of life (EOL) issue, and recording determination result in the parts selection data; and
searching that includes
performing, when the designer performs selection of a part and the EMS represents condition for the selection, similarity search with respect to parts selection data for which the determination result indicates the EMS, and
performing, when the designer performs selection of a part and the EOL issue represents condition for the selection, similarity search with respect to parts selection data for which the determination result indicates the EOL issue.
